(19) United States
(12) Patent Application Publication
(10) Pub. No.: US 2011/0168493 A1
(43) Pub. Date: Jul. 14, 2011

(54) STEP LADDER ATTACHMENT

(76) Inventor: JAY DEAN CLARK, Bixby, OK (US)

(21) Appl. No.: 12/686,906

(22) Filed: Jan. 13, 2010

(51) Int. Cl. E06C 7/14

(52) U.S. Cl. 182/129

(57) ABSTRACT

An apparatus, that can be manufactured by injection mold technology, easily attachable to and detachable from the top cap of a step ladder and for use mainly by carpenters, electricians, plumbers, and painters for holding tools, paintbrushes, paint cans and the like. The apparatus works with “old style” (simple wooden top, or similar) step ladders by sliding and/or hooking onto the step ladder's top cap via a folding “lip & tooth” and with “new style” (WERNER® top, or similar) step ladders by mating at least one “tooth” protruding from the folding “lip & tooth” with a corresponding slit(s) found on the top cap's edge.

### CROSS-REFERENCE TO RELATED APPLICATIONS

N/A

### STATEMENT REGARDING FEDERALLY SPONSORED RESEARCH OR DEVELOPMENT

N/A

### THE NAMES OF THE PARTIES TO A JOINT RESEARCH AGREEMENT

N/A

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

N/A

### BACKGROUND OF THE INVENTION

1. Field of the Invention

The present invention relates generally to step ladder attachments. More particularly, the present invention relates to a one-piece, readily attachable and detachable step ladder attachment used to retain tools and supplies.

2. Description of Related Art

Step ladders allow individuals to work at elevated positions. Maintaining control over tools and gear while working at the top of a step ladder often increases the risk of falls and injuries. Providing locations where tools, paintbrushes, paint cans and the like are readily accessible and conveniently retainable and retrievable allow a worker free use of both hands and reduces the risk of falling.

It is an object of this invention to:

Provide an improved step ladder attachment that may be easily and efficiently manufactured and marketed;

Provide an improved step ladder attachment that can be fabricated from plastic and lends itself to injection mold technology;

Provide an improved step ladder attachment that can be fabricated in a single piece with no moving parts and requires no additional parts for its proper and intended use;

Provide an improved step ladder attachment that is of a durable and reliable construction;

Provide an improved step ladder attachment that is easy and convenient to use;

Provide an improved step ladder attachment having low manufacturing costs with regard to both materials and labor, and therefore, suitable for low selling prices to consumers, thereby making the step ladder attachment economically available to a larger portion of consumers;

Provide an improved step ladder attachment that provides in the apparatuses and methods of the prior art some of the advantages thereof, while simultaneously overcoming some of the disadvantages normally associated therewith;

Provide an improved step ladder attachment that increases the surface area of the top cap of a step ladder;

Provide an improved step ladder attachment that may be used with both “old style” and “new style” step ladders;

Provide an improved step ladder attachment that contains ring members, hole members, and pouch members for holding various items.

These together with other objects of this invention, along with the various features of novelty that characterize the invention, are pointed out with particularity in the claims annexed to and forming a part of this disclosure. For a better understanding of the invention, its use advantages and specific objects attained by its uses, reference should be made to the accompanying drawings and descriptive matter in which there are illustrated preferred embodiments of the invention.

### BRIEF SUMMARY OF THE INVENTION

The present invention provides an apparatus, that can be manufactured by injection mold technology, easily attachable to and detachable from the top cap of a step ladder and for use mainly by carpenters, electricians, plumbers, and painters for holding tools, paintbrushes, paint cans and the like. The apparatus works with “old style” (simple wooden top, or similar) step ladders by sliding and/or hooking onto the step ladder's top cap via a folding “lip & tooth” and with “new style” (WERNER top, or similar) step ladders by mating at least one “tooth” protruding from the folding “lip & tooth” with a corresponding slit(s) found on the top cap's edge.

The present invention has an appreciation for and speaks to various drawbacks of prior art. Prior art often requires the use of latches, screws, hinges, straps, springs, wing nuts, buckles, and is of multi-piece construction. Accordingly, it is the primary intention of this invention to provide an improved step ladder attachment notable for simplicity in manufacture and use.

Various combinations and sub-combinations of the disclosed elements, as discussed in detail below, achieve other features and embodiments of the present invention.

### BRIEF DESCRIPTION OF THE SEVERAL VIEWS OF THE DRAWINGS

A preferred embodiment of the present invention is described in detail below with reference to the attached drawing figures, wherein:

FIG. 1 illustrates a perspective view of the invention in use.

FIG. 2 illustrates a perspective view of the invention in use.

FIG. 3 illustrates an additional view of the invention.

### DETAILED DESCRIPTION OF THE INVENTION

The embodiments discussed herein are merely illustrative of specific manners in which to make and use the invention and are not to be interpreted as limiting the scope of the instant invention.

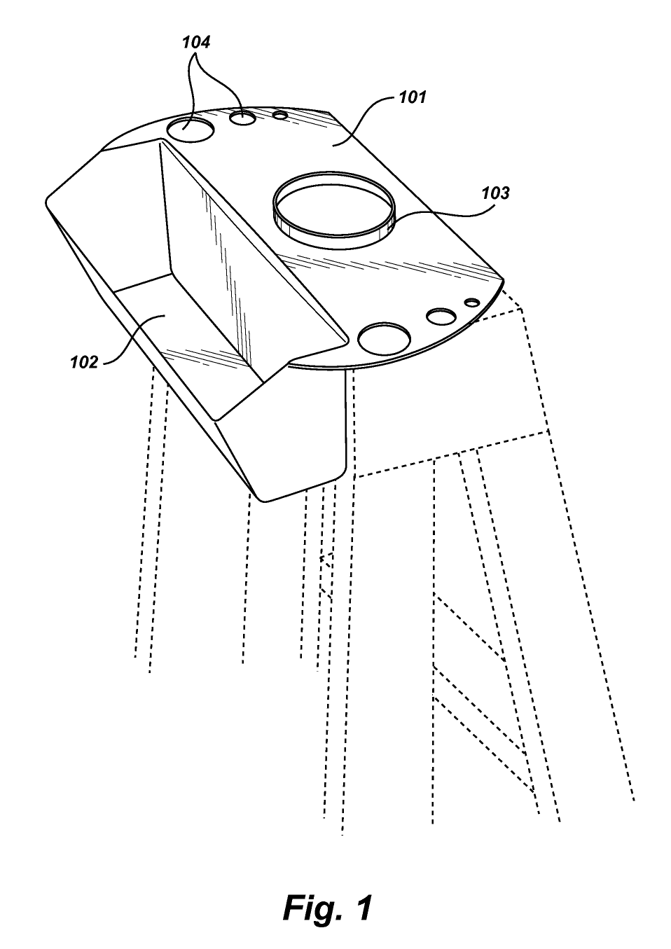

Referring to the drawings in detail, FIG. 1 illustrates a view of one embodiment of the invention attached to a ladder. The plate (101) is formed to sit flatly on the top cap of a step ladder and includes a pouch (102), a ring (103) formed on the plate, and holes (104) formed in the plate. The ring may be fashioned as a protrusion (shown) or as a depression (not shown). Additional embodiments of the claimed invention may include a single ring (as shown) or multiple rings of various sizes (not shown). Additional embodiments of the claimed invention may include a single pouch (as shown) or multiple pouches of various sizes (not shown).

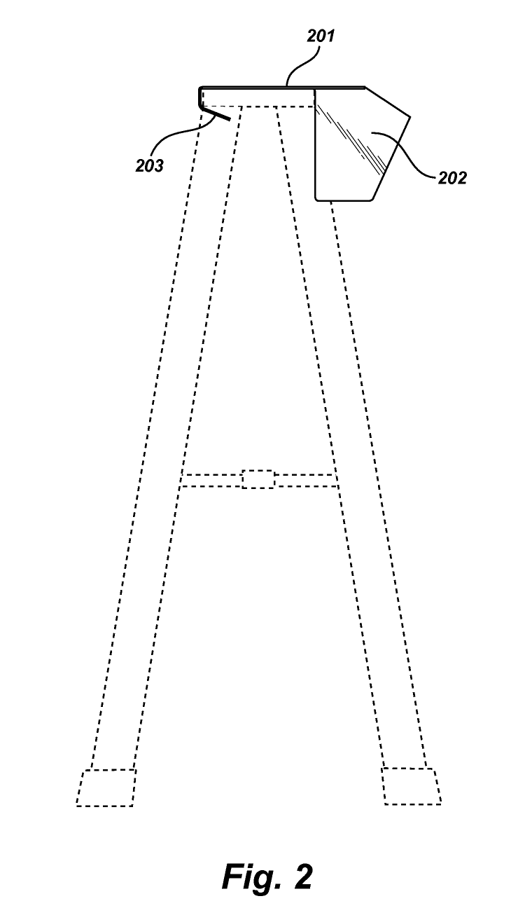

FIG. 2 illustrates another view of one embodiment of the invention attached to a ladder. The plate (201) sits flatly on the top cap of a step ladder and includes a pouch (202), and a lip & tooth segment (203) formed by folding an edge of said plate downward at least one quarter of one inch at an angle of between 45 and 135 degrees, said edge having at least one tooth connected to said folded edge and protruding there from and under said plate a distance of at least one quarter of one inch.

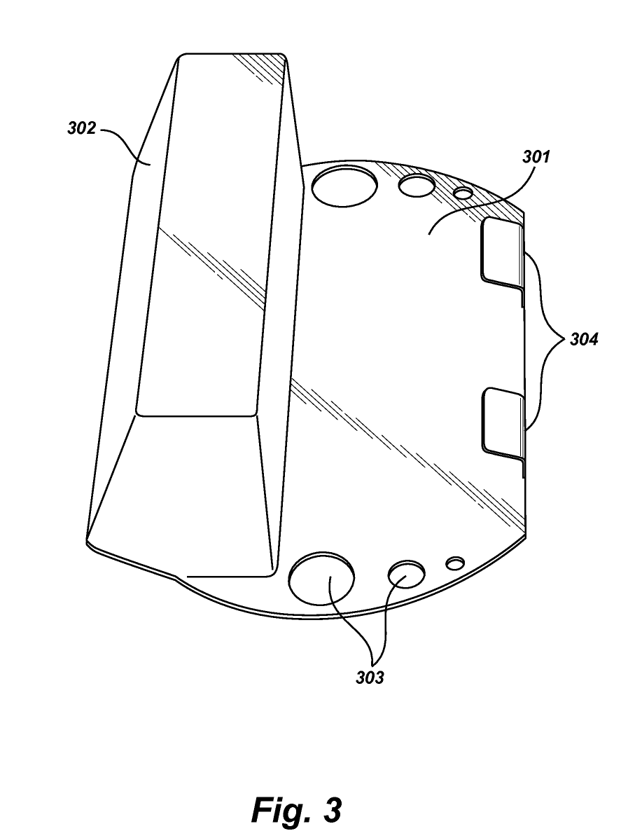

FIG. 3 illustrates a bottom view of one embodiment of the invention. The plate (301) is formed to sit flatly on the top cap of a step ladder and includes a pouch (302), holes (303) formed in the plate, and a lip & tooth segment formed by folding an edge of said plate downward at least one quarter of one inch at an angle of between 45 and 135 degrees, said edge having at least one tooth (304) connected to said folded edge and protruding there from and under said plate a distance of at least one quarter of one inch.

While the invention has been described with a certain degree of particularity, it is to be noted that modifications may be made in the details of the invention's construction and the arrangement of its components without departing from the spirit and scope of this disclosure. It is understood that the invention is not limited to the embodiments set forth herein for the purposes of exemplification.

The invention claimed is:

1. An object acquiring and retaining apparatus adapted for use with a step ladder having a pair of front side rails or legs, a pair of back side rails or legs, steps, and a top cap, said object acquiring and retaining apparatus comprising:
a. a plate with at least one edge of said plate folded downward at least one quarter of one inch at an angle of between 45 and 135 degrees, said edge(s) having at least one tooth connected to said folded edge and protruding there from and under said plate a distance of at least one quarter of one inch.

2. The apparatus as recited in claim 1, further comprising:
a. at least one pouch section connected to said plate having an open top, closed bottom and sides.

3. The apparatus as recited in claim 1, further comprising:
a. one or more rings on said plate.

4. The apparatus as recited in claim 2, further comprising:
a. one or more rings on said plate.

5. The apparatus as recited in claim 1, 2, 3 or 4, further comprising:
a. one or more holes in said plate.
